(19) United States
(12) Patent Application Publication
(10) Pub. No.: US 2014/0067211 A1
(43) Pub. Date: Mar. 6, 2014

(54) SYSTEM AND METHOD FOR AUTOMATICALLY CONTROLLING VEHICLE SPEED

(71) Applicants: HYUNDAI MOTOR COMPANY, (US); KIA MOTORS CORPORATION, (US)

(72) Inventor: Sang Joon Kim, Seoul (KR)

(73) Assignees: KIA MOTORS CORPORATION, Seoul (KR); HYUNDAI MOTOR COMPANY, Seoul (KR)

(21) Appl. No.: 13/710,019

(22) Filed: Dec. 10, 2012

(30) Foreign Application Priority Data
Sep. 6, 2012 (KR) 10-2012-0098871

(51) Int. Cl. B60W 30/14; B60W 10/18; B60W 10/10; B60W 10/06

(52) U.S. Cl. CPC B60W 30/143; B60W 10/06; B60W 10/18; B60W 10/10
USPC 701/54; 701/93

(57) ABSTRACT

Disclosed is a system and a method for automatically controlling a vehicle speed. The method of automatically controls a driving speed of the vehicle to be a set target vehicle speed by: detecting the driving speed of the vehicle; determining a slope of a driving road; and when the driving road is an inclined road, controlling the driving speed of the vehicle to be the target vehicle speed based on a driving resistance value which reflects an inclination angle of the inclined road.

### CROSS-REFERENCE TO RELATED APPLICATION

This application claims priority to and the benefit of Korean Patent Application No. 10-2012-0098871 filed in the Korean Intellectual Property Office on Sep. 6, 2012, the entire contents of which are incorporated herein by reference.

### BACKGROUND OF THE INVENTION

(a) Field of the Invention

The present invention relates to a system and a method for automatically controlling a vehicle speed.

(b) Description of the Related Art

Systems for automatically controlling a vehicle (auto cruise control system (ACC)) have been developed such that a driving speed of a vehicle is uniformly maintained at a set speed without help of a person. (i.e. a driver does not manipulate a mechanism, such as an accelerator pedal and a brake pedal, that controls vehicle speed).

Such systems for automatically controlling a vehicle are disclosed in U.S. Patent Publication Nos. 20050240334, 20060212207, 20060100769, and the like.

According to these systems, feedback control is performed in order to control a speed of the vehicle. The feedback control is generally a proportional integral control.

However, as illustrated in FIG. 1, such systems are problematic in that undershoot of a vehicle speed is generated when a vehicle travels from a flat road to an inclined road, and overshoot of a vehicle speed is generated when a vehicle travels from an inclined road to a flat road.

In particular, these systems control without considering a change in a driving road, so that an error of a vehicle speed is excessively generated when there is a change in a grade (slope) of a driving road.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a system and a method for automatically controlling a vehicle speed, which uses both feedback control and feedforward control in order to improve control of the vehicle speed at a target vehicle speed. The system and method differentiate a driving resistance value applied to the feedforward control according to a slope of the road on which the vehicle is travelling, thereby effectively suppressing generation of undershoot or overshoot of the vehicle speed when the incline of the road changes. The present system and method, thus, provide smooth driving of the vehicle. According to embodiments of the present invention, the system and a method for automatically controlling a vehicle speed accurately calculates driving resistance on an inclined road. In particular, the system and method detect an inclined road through a longitudinal detector that includes a longitudinal acceleration sensor. As such, a response characteristic in vehicle speed control is improved.

According to one aspect, the present invention provides a method for automatically controlling a driving speed of a vehicle to a set target vehicle speed, the method including: detecting the driving speed of the vehicle; determining a slope of the road on which the vehicle is driving (“driving road”); and if the driving road is an inclined road, controlling the driving speed of the vehicle to be the target vehicle speed based on a driving resistance value which takes into account an inclination angle of the inclined road.

According to various embodiments, in controlling the driving speed of the vehicle to be the target vehicle speed, the driving resistance value is a feedforward control value.

According to various embodiments, determining the inclination of the driving road is performed by using a longitudinal acceleration detector configured to detect a longitudinal inclination of the vehicle.

According to various embodiments, the driving resistance value is calculated based on a rolling resistance value, an air resistance value, and an inclination value. In particular, the rolling resistance value is based on rolling of the wheels on the inclined road, the air resistance value is based on air resistance of the vehicle body on the inclined road, and the inclination resistance value is based on the inclination of the inclined road.

According to various embodiments, the driving speed of the vehicle may be fed back and used for feedback controlling the driving speed of the vehicle to the target vehicle speed.

According to various embodiments, the method of automatically controlling the vehicle speed may further include determining whether an output signal of the longitudinal acceleration detector is maintained for a set time or longer. When it is determined that the output signal of the longitudinal acceleration detector is maintained for the set time or longer, then the driving speed of the vehicle is controlled to be the target vehicle speed based on the driving resistance.

According to another aspect, a system for automatically controlling a vehicle speed is provided which includes: a longitudinal acceleration sensor configured to detect a longitudinal inclination of the vehicle; a vehicle speed detector configured to detect a driving speed of the vehicle; a controlled target including an engine, a transmission, and a braking device for controlling the driving speed of the vehicle; and a vehicle speed controller configured to receive signals from the longitudinal acceleration sensor and the vehicle speed detector, and to control the driving speed of the vehicle to be the target vehicle speed by controlling the controlled target. According to various embodiments, the vehicle speed controller is operated by a set program including a series of commands for performing a method of automatically controlling a vehicle speed.

According to various embodiments, the vehicle speed controller includes: a feedback controller configured to feedback control a vehicle speed based on a vehicle speed signal output from the vehicle speed detector; a driving resistance measuring device configured to measure driving resistance of the vehicle; and a feedforward controller configured to feedforward control a vehicle speed based on a driving resistance value measured by the driving resistance measuring device.

According to various embodiments, the driving resistance measuring device includes: a rolling resistance measuring device configured to measure resistance based on rolling of the vehicle wheels; an air resistance measuring device configured to measure air resistance of the vehicle body while driving; and a slope resistance measuring device configured to measure slope resistance of an inclined road based on an output signal of the longitudinal acceleration sensor.

According to various embodiments, the rolling resistance measuring device calculates a rolling resistance value as a value (F_{rolling}) by Equation (1) below, the air resistance measuring device calculates an air resistance value as a value (F_{aerodynamic}) by Equation (2) below, and the slope resistance measuring device calculates an inclination resistance value as a value (F_{climbing}) by Equation (3) below.

$$\begin{matrix}{F}_{rolling} = {μ}_{tire} \cdot {m}_{vehicle} \cdot gravity & Equation ( 1 ) \\ {F}_{aerodynamic} = \frac{1}{2} \cdot {ρ}_{air } \cdot {C}_{d} \cdot A \cdot {v}^{2} & Equation ( 2 ) \\ {F}_{climbing} = {m}_{vehicle} \cdot gravity \cdot sin θ & Equation ( 3 )\end{matrix}$$

As described above, according to embodiments of the present invention, the feedback control and the feedforward control are used together in order to control the vehicle speed to be a target vehicle speed. Further, a driving resistance value according to an inclination angle of an inclined road is immediately reflected to the feedforward control when the incline of the road varies (such as when the vehicle travels from a flat road to an inclined road or from an inclined road to a flat road), thereby stably maintaining the vehicle speed at a target vehicle speed without undershoot and overshoot of the vehicle speed.

Further, according to the exemplary embodiments of the present invention, driving resistance on an inclined road is accurately calculated by detecting an inclined road through the longitudinal acceleration detector which includes the longitudinal acceleration sensor, thereby improving a response characteristic in vehicle speed control and smooth driving of a vehicle.

### BRIEF DESCRIPTION OF THE DRAWINGS

FIG. 1 is a graph illustrating undershoot and overshoot generated in a conventional method and system for automatically controlling a vehicle speed.

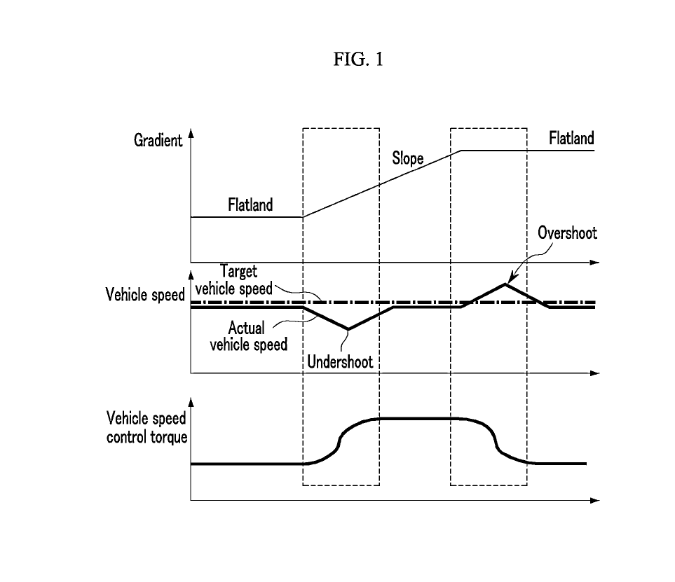

FIG. 2 is a configuration diagram of a system for automatically controlling a vehicle speed according to an embodiment of the present invention.

FIG. 3 is a flowchart of a method for automatically controlling a vehicle speed according to an embodiment of the present invention.

FIG. 4 is an operational graph of a system and a method for automatically controlling a vehicle speed according to an embodiment of the present invention.

FIG. 5 is a conceptual diagram describing driving resistance generated when a vehicle travels up an inclined road in accordance with an embodiment of the present invention.

### DETAILED DESCRIPTION OF THE EMBODIMENTS

Hereinafter, exemplary embodiments of the present invention will be described with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

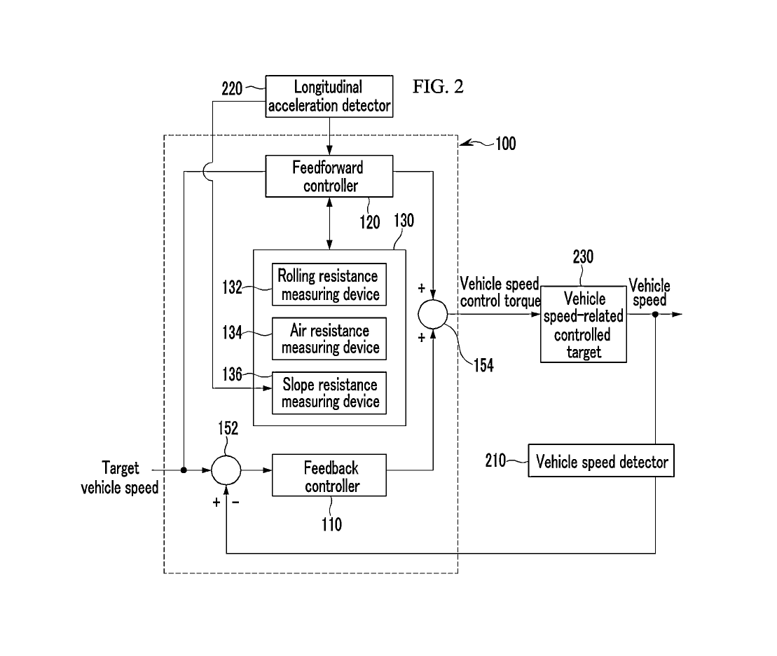

FIG. 2 is a block diagram depicting a system for automatically controlling a vehicle speed according to an embodiment of the present invention.

The system for automatically controlling the vehicle speed according to the exemplary embodiment of the present invention uniformly maintains a driving speed of a vehicle at a set speed without the help of a driver.

According to an exemplary embodiment, the system includes: a longitudinal acceleration detector 220 for detecting a longitudinal inclination of a vehicle; a vehicle speed detector 210 for detecting a speed of the vehicle; a controlled target 230 for controlling a driving speed of the vehicle, the controlled target 230 including an engine, a transmission, and a braking device; and a vehicle speed controller 100 for controlling the controlled target 230 by receiving signals from the longitudinal acceleration detector 220 and the vehicle speed detector 210 and controlling a vehicle speed to be a set target speed.

In the exemplary embodiment of the present invention, the vehicle speed detector 210 is in the form of a vehicle speed sensor attached to one or more wheels of the vehicle and configured to detect revolutions per minute. According to another example, the vehicle speed detector 210 is in the form of a vehicle speed sensor attached to a final reduction gear of a transmission. However, the configuration of the vehicle speed detector 210 can vary and, thus, is not limited to these example. Rather, the present invention could include a variety of vehicle speed detector 210 configurations capable of calculating a value corresponding to an actual vehicle speed.

According to embodiments of the present invention, the longitudinal acceleration detector 220 is provided with any configuration capable of calculating a value corresponding to an actual longitudinal inclination of a vehicle. For example, the longitudinal acceleration detector 220 may comprise a longitudinal acceleration sensor mounted to one or more wheels to detect a longitudinal inclination of the vehicle. According to another example, the longitudinal acceleration detector 220 may comprise a longitudinal acceleration sensor such as that provided in an anti-lock braking system (ABS).

According to embodiments of the present invention, the vehicle speed controller 100 comprises one or more microprocessors operated by a set program, and the set program may include a series of commands for performing a method of automatically controlling a vehicle speed.

According to an embodiment of the present invention, the vehicle speed controller 100 includes: a feedback controller 110 for feedback controlling the vehicle speed based on a vehicle speed signal output from the vehicle speed detector 210; a driving resistance measuring device 130 for measuring driving resistance of the vehicle; and a feedforward controller 120 for feedforward controlling the vehicle speed based on the driving resistance value measured by the driving resistance measuring device 130.

According to an exemplary embodiment, the feedback controller 110 is formed as a proportional integral (PI) controller. However, the feedback controller 110 is not limited as such. Rather, the technical spirit of the present invention may be applied to any configuration of a feedback controller 110 that is capable of controlling vehicle speed corresponding to the actual feedback control.

General control operations of the feedback controller 110 and the feedforward controller 120 could be determined by one skilled in the art, and thus more detailed descriptions thereof will be omitted.

In a method for automatically controlling a vehicle speed according to an exemplary embodiment of the present, partial processes may be performed by the feedback controller 110, further partial processes may be performed by the feedforward controller 120, and yet further partial processes may be performed by the driving resistance measuring device 130. However, it should be understood that the scope of the present invention is not limited as such. The controller and/or the measuring device may be implemented by a combination of components different than that described in the exemplary embodiment. Further, the feedback controller 110 and the feedforward controller 120 may perform a combination of processes different than that described in the exemplary embodiment of the present invention.

According to an embodiment the driving resistance measuring device 130 includes: a rolling resistance measuring device 132 for measuring resistance according to rolling of the vehicle wheels; an air resistance measuring device 134 for measuring air resistance of the vehicle body during driving; and a slope resistance measuring device 136 for measuring slope resistance on an inclined road based on an output signal of the longitudinal acceleration detector 220.

The rolling resistance measuring device 132 may calculate a rolling resistance value as a value (F_{rolling}) of Equation (1) below.

F_{rolling}=μₜᵢᵣₑ·m_{vehicle}·gravity Equation (1)

The air resistance measuring device 134 may calculate an air resistance value as a value (F_{aerodynamic}) of Equation (2) below.

$${F}_{aerodynamic} = \frac{1}{2} \cdot {ρ}_{air} \cdot {C}_{d} \cdot A \cdot {v}^{2} \qquad Equation ( 2 )$$

The slope resistance measuring device 136 may calculate an inclination resistance value as a value (F_{climbing}) of Equation (3) below.

F_{climbing}=m_{vehicle}·gravity·sin θ Equation (3)

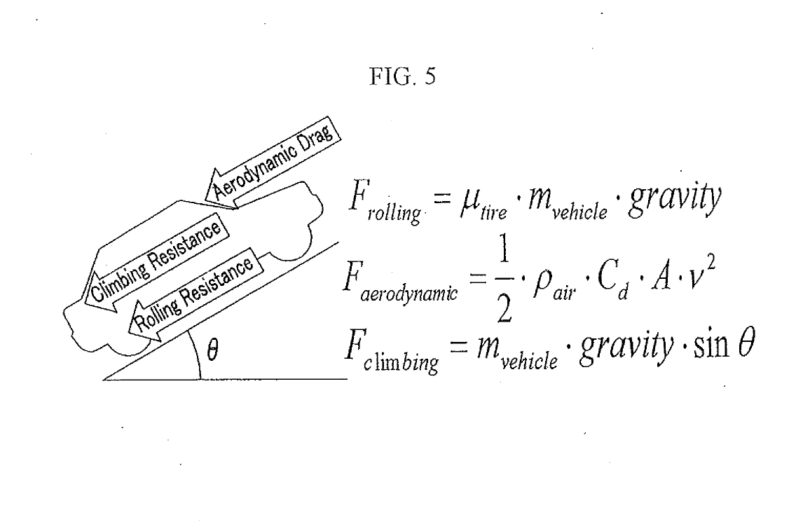

An output signal value (long_accel_val) of the longitudinal acceleration detector 220 and an inclination angle (θ) according to the output signal value may then be obtained by the equations below, for example, when the vehicle travels an inclined road having an inclination angle of θ as illustrated in FIG. 5. In the equations below, M is a vehicle weight, a is a vehicle driving acceleration, and g is a gravity acceleration.

$$Ma = F - ( {F}_{aerodynamic} + {F}_{Rolling} + {F}_{Climbing} )$$

$$Ma = F - ( {F}_{aerodynamic} + {F}_{Rolling} + Mg sin θ )$$

$$F - ( {F}_{aerodynamic} + {F}_{Rolling} ) = M \cdot ( a + g sin θ )$$

$$long\_accel \_val = a + g sin θ$$

$$g sin θ = long\_accel \_val - a$$

$$sin θ ≅ θ = \frac{1}{g} ( long\_accel \_val - a ) \\ ∴ θ = \frac{1}{g} ( long\_accel \_val - a )$$

In FIG. 2, a combiner 152 of the vehicle speed controller 100 is configured and arranged for combining the vehicle speed detected by the vehicle speed detector 210 with a target vehicle speed set by a driver or a user, and transmitting the combined vehicle speed to the feedback controller 110.

In FIG. 2, a combiner 154 of the vehicle speed controller 100 is configured and arranged for combining control signals output from the feedback controller 110 and the feedforward controller 120 to control the controlled target 230.

Hereinafter, a method of automatically controlling a vehicle speed according to an exemplary embodiment of the present invention will be described with reference to the accompanying drawings.

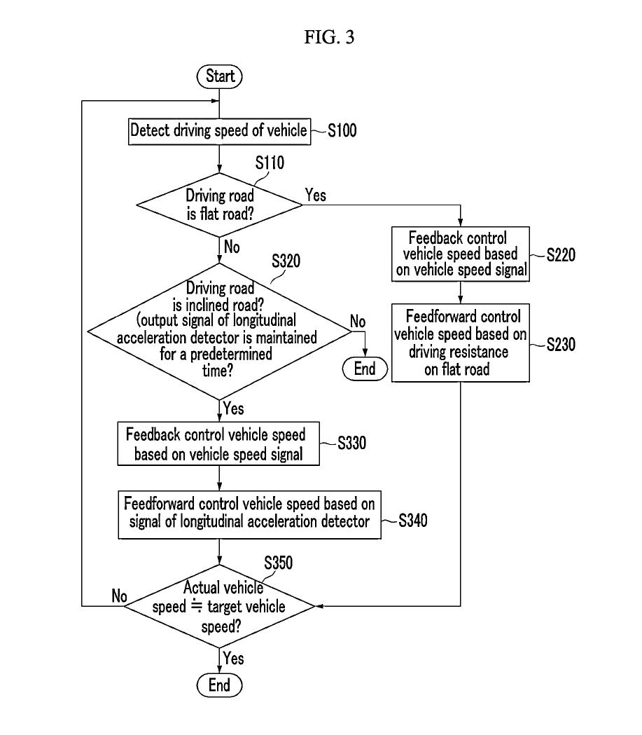

In particular, FIG. 3 is a flowchart showing a method of automatically controlling a vehicle speed according to the exemplary embodiment. According to the method, a vehicle speed is automatically controlled to be a target vehicle speed by using the feedback control and the feedforward control.

As illustrated in FIG. 3, the vehicle speed controller 100 detects a driving speed of a vehicle through an output signal of the vehicle speed detector 210 (S100). The vehicle speed controller 100 then determines whether a driving road is flat or inclined based on an output signal value (long_accel_val) of the longitudinal acceleration detector 220 which detects a longitudinal inclination of the vehicle (S110 and S320).

In process S320, when the inclination angle (θ) by the output signal (long_accel_val) of the longitudinal acceleration detector 220 is equal to or larger than 0 degree, the feedforward controller 120 and the slope resistance measuring device 136 of the vehicle speed controller 100 may immediately determine that the driving road is an inclined road. However, in the exemplary embodiment of the present invention, in order to discriminate a temporal change in a driving road, when the inclination angle detected by the longitudinal acceleration detector 220 is equal to or larger than 0 degree and that inclination angle is maintained for a predetermined time (for example, three seconds) or longer, then the feedforward controller 120 and the slope resistance measuring device 136 of the vehicle speed controller 100 may determine that the driving road is an inclined road.

The feedforward controller 120 and the slope resistance measuring device 136 of the vehicle speed controller 100 determines that the inclined road is an ascent slope when the inclination angle detected by the longitudinal acceleration detector 220 is a positive (+) value, and determines that the inclined road is a descent slope when the inclination angle detected by the longitudinal acceleration detector 220 is a negative (−) value. However, it should be understood that the scope of the present invention is not limited as such. For example, the present invention may be applied to a configuration wherein a value of the inclination angle is a value corresponding to an actual ascent or descent inclined road even though the value has an opposite value or a different value.

When it is determined in the determination in process S110 that the driving road is a flat road, the feedback controller 110 of the vehicle speed controller 100 controls the vehicle speed (vehicle driving speed) to be a set target vehicle speed while feedback speed controlling the vehicle speed-related control target 230 based on the vehicle speed signal output from the vehicle speed detector 210 (S220).

Further, the feedforward controller 120 controls the vehicle speed to be a set target vehicle speed while feedforward speed controlling the vehicle speed-related control target 230 based on the driving resistance value on the flat road measured by the driving resistance measuring device 130 (S230). In other words, the feedforward controller 120 feedforward controls the vehicle speed-related control target 230 based on a rolling resistance value measured by the rolling resistance measuring device 132, and an air resistance value measured by the air resistance measuring device 134.

When the driving road is the flat road, the inclination angle detected by the longitudinal acceleration detector 220 is 0 degree, so that the inclination resistance value of the vehicle measured by the slope resistance measuring device 136 is 0. Accordingly, when the vehicle travels on the flat road, the inclination resistance value is not reflected to the vehicle speed controller 100.

When it is determined that the driving road is an inclined road in process S320, the feedback controller 110 feedback controls the vehicle speed-related control target 230 based on the vehicle speed signal output from the vehicle speed detector 210 similar to a case of travel on a flat road (S330).

In the meantime, the feedforward controller 120 controls the vehicle speed to be a set target vehicle speed while feedforward controlling the vehicle speed-related control target 230 based on the driving resistance value on the inclined road measured by the driving resistance measuring device 130 (S340).

When the driving road is an inclined road, the rolling resistance value (F_{rolling}) and the air resistance value (F_{aerodynamic}) are different then the values when the driving road is a flat road as illustrated in FIG. 5. For example, when the vehicle travels an inclined road, the rolling resistance value may be larger than the rolling resistance value when the vehicle travels a flat road. Further, the air resistance value when the vehicle travels on an inclined road may be smaller than the air resistance value when the vehicle travels a flat road.

Further, when the vehicle travels on an inclined road, the inclination angle detected by the longitudinal acceleration detector 220 is not 0 degree. Thus, the inclination resistance value (F_{climbing}) is measured and output by the slope resistance measuring device 136.

Accordingly, when the vehicle travels on an inclined road, the rolling resistance value, the air resistance value, and the inclination resistance value (in which the inclination angle detected by the longitudinal acceleration detector 220 is reflected) are taken into account in controlling the vehicle speed.

That is, when the vehicle travels the inclined road, the rolling resistance measuring device 132, the air resistance measuring device 134, and the slope resistance measuring device 136 measure the rolling resistance value, the air resistance value, and the inclination resistance value (in which the inclination angle detected by the longitudinal acceleration detector 220 is reflected), and provides the measured values to the feedforward controller 120, respectively.

When the rolling resistance value, the air resistance value, and the inclination resistance value are provided to the feedforward controller 120, the feedforward controller 120 feedforward controls the vehicle speed-related control target 230 based on the driving resistance value in which the inclination angle is reflected.

Accordingly, the vehicle speed controller 100 controls the actual vehicle speed to have the target vehicle speed through the feedback vehicle speed control and feedforward vehicle speed control. This feedback vehicle speed control is based on the vehicle speed signal output from the vehicle speed detector 210, and the feedforward vehicle speed control is based on the driving resistance value to which a degree of the inclination of the inclined road is reflected during the traveling of the inclined road (S350).

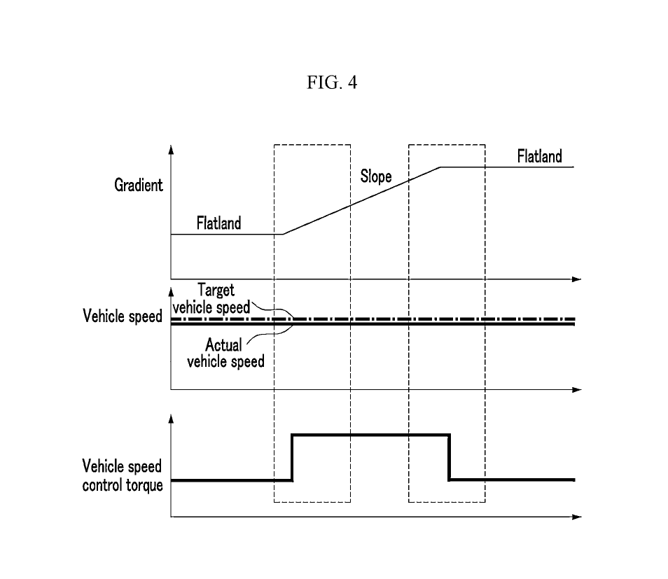

Thus, as illustrated in FIG. 4, according to the exemplary embodiment of the present invention, the driving resistance value taking into account the inclination angle of an inclined road is immediately reflected through the feedforward control when the vehicle travels and the inclination of the road varies (e.g. when the road changes from a flat road to an inclined road or from an inclined road to a flat road). As such, it is possible to stably maintain the vehicle speed at a target speed without undershoot and overshoot of the vehicle speed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: Vehicle speed controller

110: Feedback controller

120: Feedforward controller

130: Driving resistance measuring device

132: Rolling resistance measuring device

134: Air resistance measuring device

136: Slope resistance measuring device

210: Vehicle speed detector

220: Longitudinal acceleration detector

What is claimed is:

1. A method for automatically controlling a driving speed of a vehicle to be a set target vehicle speed executed by a processor within a controller, the method comprising:
detecting the driving speed of the vehicle;
determining a slope of a road on which the vehicle is driving; and
when it is determined that the road is an inclined road, determining a driving resistance value that reflects an inclination angle of the inclined road, and controlling the driving speed of the vehicle to be the target vehicle speed based on the driving resistance value.

2. The method of claim 1, wherein:
the driving resistance value is reflected is a feedforward control value.

3. The method of claim 2, wherein:
the inclination angle of the driving road is determined by using a longitudinal acceleration detector configured to detect a longitudinal inclination of the vehicle.

4. The method of claim 3, wherein:
the driving resistance value is calculated based on
a rolling resistance value based on rolling of the vehicle wheels on the inclined road,
an air resistance value based on air resistance of a body of the vehicle on the inclined road, and
an inclination resistance value based on the inclination of the inclined road.

5. The method of claim 4, wherein:
the driving speed of the vehicle is fed back to be used for feedback controlling the driving speed of the vehicle to be the target vehicle speed.

6. The method of claim 3, further comprising:
determining whether an output signal of the longitudinal acceleration detector is maintained for a set time or longer, and
when the output signal of the longitudinal acceleration detector is maintained for the set time or longer, controlling the driving speed of the vehicle to be the target vehicle speed based on the driving resistance value.

7. A system for automatically controlling a vehicle speed, comprising:
a longitudinal acceleration sensor configured to detect a longitudinal inclination of the vehicle;
a vehicle speed detector configured to detect a driving speed of the vehicle;
a controlled target comprising an engine, a transmission, and a braking device configured to control the driving speed of the vehicle; and
a vehicle speed controller configured to receive signals from the longitudinal acceleration sensor and the vehicle speed detector, and to control the driving speed of the vehicle to be the target vehicle speed by controlling the controlled target,
wherein the vehicle speed controller
is operated by a set program including a series of commands for performing a method of automatically controlling a vehicle speed, the method comprising: detecting the driving speed of the vehicle; determining a slope of a driving road; controlling the driving speed of the vehicle to be the target vehicle speed based on a driving resistance value which takes into account an inclination angle of the driving road when the driving is inclined.

8. The system of claim 7, wherein:
the vehicle speed controller comprises:
a feedback controller configured to feedback control a vehicle speed based on a vehicle speed signal output from the vehicle speed detector;
a driving resistance measuring device configured to measure driving resistance of the vehicle; and
a feedforward controller configured to feedforward control a vehicle speed based on a driving resistance value measured by the driving resistance measuring device.

9. The system of claim 8, wherein:
the driving resistance measuring device comprises:
a rolling resistance measuring device configured to measure resistance based on rolling of the vehicle wheels;
an air resistance measuring device configured to measure air resistance of a body of the vehicle while driving; and
a slope resistance measuring device configured to measure slope resistance of an inclined road based on an output signal of the longitudinal acceleration sensor.

10. A non-transitory computer readable medium containing program instructions executed by a processor, the computer readable medium comprising:
program instructions that detect a driving speed of a vehicle;
program instructions that determine a slope of a road on which the vehicle is driving; and
program instructions that determine a driving resistance value that reflects an inclination angle of the inclined road when it is determined that the road is an inclined road, and that control the driving speed of the vehicle to be the target vehicle speed based on the driving resistance value.
